(19) United States
(12) Patent Application Publication
(10) Pub. No.: US 2014/0098782 A1
(43) Pub. Date: Apr. 10, 2014

(54) ENHANCEMENT FOR LTE COMMUNICATION SYSTEMS

(71) Applicant: SIERRA WIRELESS. INC., Richmond (CA)

(72) Inventors: Ghasem Naddafzadeh Shirazi, Vancouver (CA); Lutz Hans-Joachim Lampe, Vancouver (CA); Gustav Gerald VOS, Surrey (CA); Steven John Bennett, Coquitlam (CA)

(73) Assignee: SIERRA WIRELESS. INC., Richmond (CA)

(21) Appl. No.: 14/046,733

(22) Filed: Oct. 4, 2013

Related U.S. Application Data
(60) Provisional application No. 61/710,583, filed on Oct. 5, 2012.

(51) Int. Cl. H04W 72/04; H04B 1/707

(52) U.S. Cl. CPC H04W 72/04; H04B 1/707
USPC 370/330; 370/329

(57) ABSTRACT

A method and system for transmitting data from a UE in an OFDM system such as LTE. Information symbols are spread using a spreading code assigned to the UE and orthogonal to spreading codes of other UEs. The assigned spreading code has a spreading factor which is variable and dynamically selected based on one or more system performance criteria. The spread information symbols are transmitted in one or more LTE resource blocks. Spreading may be performed in the time domain, over a plurality of LTE time slots and/or resource elements.

### CROSS-REFERENCE TO RELATED APPLICATIONS

This application is a utility application which claims the benefit of priority under 35 U.S.C. §119(e) of U.S. provisional application Ser. No. 61/710,583, filed Oct. 5, 2012, which is hereby incorporated by reference in its entirety, including all tables, figures, and claims.

### FIELD OF THE TECHNOLOGY

The present technology pertains in general to wireless communication systems, and in particular to methods and systems for providing enhanced Long-Term Evolution (LTE) systems.

### BACKGROUND

The latest generation cellular radio standard known as LTE (Long Term Evolution) has been designed to provide high data rate capacity and good spectral efficiency in terms of bits per second per Hz. This serves the needs of smartphones, tablet and laptop computers that offer high data capacity using applications such as video streaming. M2M (Machine to Machine) applications of cellular radio in many cases require only a modest amount of data capacity. In many cases communication is short and intermittent and the “mobile” M2M device may not move, or may have limited mobility and low velocity. This is a significantly different use case from the uses that drove the LTE specification and which currently drive the chip designs for LTE. The LTE standard and the current chips therefore have more features and higher cost than are needed for many M2M applications. They also make performance trade-offs that favour high data rates. However, there is a need to optimize performance and reduce cost for hardware dedicated to M2M applications within the framework of LTE.

M2M is set for significant growth in the next few years. According to some projections, the total number of M2M connected devices may exceed the current numbers of phones, smartphones and other data communication devices. It is currently popular in the M2M modems market to use the older GSM/GPRS networks that have lower data rates, relative simplicity and lower cost. Unfortunately, this cannot be a long term solution as smartphones are migrating to the new 3G and LTE technologies. The service providers will not want to maintain the older base stations. Also, with an ongoing shortage of available bandwidth for new services the service providers want to migrate their spectrum allocations from GSM/GPRS to the newer systems that have higher capacity in a given bandwidth. LTE service may also offer a lower cost per bit that would be an additional incentive to users to upgrade. This means that eventually GSM/GPRS may no longer be supported.

The 3GPP (Third Generation Partnership Project) standards committees have recognized the need for LTE to support very large numbers of M2M UEs (User Equipment) and have identified objectives for modifications to the existing LTE standards designed to support very large numbers of M2M UEs. Common requirements for such modifications are that they maintain compatibility with existing devices and limit the impact of M2M traffic on the high data rate and low latency requirements of current and future users.

Existing standards groups have identified specific features and requirements for facilitating coexistence of a large number of M2M UEs with each other and with other classes of UEs on the LTE system. There is also an objective to provide for simpler and lower cost modems for M2M UEs that may not take advantage of some advanced LTE features. For example, LTE offers MIMO (Multiple Input Multiple Output technology) for higher capacity and more reliable communication. M2M UEs may be cost reduced by not using this feature, which requires multiple radios operating simultaneously.

The UE coverage is, in various cases, an important factor which should not be compromised when reducing the cost of M2M networks. If some UE features are omitted from an M2M UE, for example by selecting a single Transmitting (Tx) antenna, half duplex or reduced RF bandwidth, then the corresponding loss in coverage should be compensated. UE coverage may relate, for example, to whether or not a specified UE or group of UEs are capable of adequate communication with a base station, for example UEs at a given range or level of signal strength.

Cell spectral efficiency is another factor which, in various cases, should not be compromised due to LTE system modifications.

Current proposals on the subject of M2M specialization within the LTE standard are captured in the draft specification; 3rd Generation Partnership Project; Technical Specification Group Radio Access Network; Study on provision of low-cost M2M UEs based on LTE; 3GPP TR 36.888. However, this study item has not been approved for inclusion in 3GPP standard Release 11, and some of the proposed solutions for reducing the cost of M2M UEs negatively affect the coverage of LTE cells.

A separate part of 3GPP Release 11 standard, “3rd Generation Partnership Project; Technical Specification Group Radio Access Network; Evolved Universal Terrestrial Radio Access (E-UTRA); LTE coverage enhancements,” Technical Report, 3^{rd} Generation Partnership Project, TR 36.824 V11.0.0, June 2012, hereinafter referred to as TR 36.824, addresses the issue of coverage enhancement using transmission time interval (TTI) bundling with retransmissions, which “involves repeating the coded bits [same code (turbo codes rate ⅓), but with different redundancy version indices for initiating the cyclic-buffer rate-matching]. An alternative way of achieving repetition is to use spreading, which has the additional benefit of increasing the robustness with respect to interference. A similar structure as PUCCH format 3 (F3) could be used in order to add the spreading dimension. It is for further study to extend TTI bundling to more TDD DL/UL configurations.” TTI bundling combined with F3 spreading can provide coverage gain and can accommodate up to 5 users in the bundled TTIs. Increasing the bundling size from 4 to 8 is studied in some 3GPP technical documents, including 3GPP TSG RAN WG1 Meeting #68bis “Further discussion on coverage enhancement”, March 2012, 3^{rd} Generation Partnership Project, http://www.3gpp.org/ftp/tsg_ran/WG1_RL1/TSGR1_{—}68b/Docs/R1-121005.zip, hereinafter referred to as R1-121005, where it is also shown that if the delay bound can be relaxed, the number of uplink (UL) sub-frames for one packet should be increased for a better coverage.

However, the suggested methods in TR 36.824 and R1-121005 suffer from several drawbacks. For example, these methods may be relatively inflexible for scheduling different numbers of active M2M UEs and may be unable to adjust the achieved coverage gain based on the low data rate and loose delay requirements of active M2M UEs (and other cell-edge UEs in a compatible release with similar requirements).

Therefore there is a need for a method and system for providing enhanced Long-Term Evolution (LTE) systems, for example related to coverage enhancement, that is not subject to one or more limitations of the prior art.

This background information is provided for the purpose of making known information believed by the applicant to be of possible relevance to the present technology. No admission is necessarily intended, nor should be construed, that any of the preceding information constitutes prior art against the present technology.

### SUMMARY OF THE TECHNOLOGY

An object of the present technology is to provide an enhanced LTE system or other system employing OFDM (Orthogonal Frequency Division Multiplexing) and time and frequency resource blocks. In accordance with an aspect of the present technology, there is provided a method for transmitting data from a transmitter configured for wireless communication in an OFDM system, the method comprising: obtaining information symbols indicative of said data; spreading each of the information symbols using a spreading code assigned to the transmitter, the spreading code being different from spreading codes of other transmitters in the OFDM system; and transmitting the spread information symbols in one or more time and frequency resource blocks defined for the OFDM system. In various embodiments, the spreading code has a spreading factor which is selected based on one or more system performance criteria. In various embodiments, the spreading code is orthogonal to spreading codes of said other transmitters in the OFDM system. In various embodiments, each of the information symbols is transmitted over a plurality of time slots. In various embodiments, OFDM time slots or frequency slots or both are concurrently used for transmission by plural transmitters, with the transmissions of different transmitters differentiated by use of orthogonal spreading codes.

In accordance with another aspect of the present technology, there is provided a method for controlling data transmission from a set of transmitters in an OFDM system, the method comprising: selecting one or more transmitters from the set of transmitters; transmitting a message to the selected one or more transmitters, the message comprising instructions to transmit data in accordance with a method for transmitting data from a transmitter configured for wireless communication in an OFDM system, this method for transmitting comprises the steps of obtaining information symbols indicative of said data; spreading each of the information symbols using a spreading code assigned to the transmitter, the spreading code being different from spreading codes of other transmitters in the OFDM system; and transmitting the spread information symbols in one or more time and frequency resource blocks defined for the OFDM system; and at each of the selected one or more transmitters, accepting or rejecting said instructions.

In accordance with another aspect of the present technology, there is provided a user equipment (UE) configured for implementing enhanced communication in an LTE system, the UE comprising: a source of data; a transceiver module configured to: obtain information symbols indicative of said data; spread the information symbols using a spreading code assigned to the UE, the spreading code being substantially orthogonal to spreading codes of other UEs in the LTE system, the spreading code having a spreading factor which is selected based on one or more system performance criteria; and transmit the spread information symbols in one or more LTE resource blocks.

In accordance with another aspect of the present technology, there is provided a system configured for implementing enhanced communication in an LTE system, the system comprising: a base station (eNB); and a user equipment (UE) configured for implementing enhanced communication in an LTE system, the UE comprising: a source of data; a transceiver module configured to: obtain information symbols indicative of said data; spread the information symbols using a spreading code assigned to the UE, the spreading code being substantially orthogonal to spreading codes of other UEs in the LTE system, the spreading code having a spreading factor which is selected based on one or more system performance criteria; and transmit the spread information symbols in one or more LTE resource blocks.

In accordance with another aspect of the present technology, there is provided a computer program product comprising a computer readable memory storing computer executable instructions thereon that when executed by a computer perform a method for transmitting data in an OFDM system, the method comprising: generating or obtaining information symbols indicative of said data; spreading each of the information symbols using a spreading code assigned to a transmitter associated with the OFDM system, the spreading code being different from spreading codes of other transmitters in the OFDM system; and transmitting the spread information symbols in one or more OFDM time and frequency resource blocks. In various embodiments, the spreading code has a spreading factor which is selected based on one or more system performance criteria. In various embodiments, the spreading code is orthogonal to spreading codes of said other transmitters in the OFDM system. In various embodiments, each of the information symbols is transmitted over a plurality of time slots.

### BRIEF DESCRIPTION OF THE FIGURES

These and other features of the technology will become more apparent in the following detailed description in which reference is made to the appended drawings.

FIG. 1 illustrates a bundle of spreading blocks, in accordance with embodiments of the present technology.

FIGS. 2a to 2e illustrate spreading blocks for various values of spreading code lengths, in accordance with embodiments of the present technology.

FIG. 3 illustrates a signaling procedure between a UE and an eNB for determining operating parameters of the technology and assigning the UE to TTI-bundled spreading blocks, in accordance with embodiments of the present technology.

FIG. 4 illustrates an example of a resource allocation including time gaps, in accordance with embodiments of the present technology.

FIG. 5 illustrates a method for communicating in a wireless network, in accordance with embodiments of the present technology.

FIG. 6 illustrates a system for facilitating communication in a wireless network, in accordance with embodiments of the present technology.

FIG. 7 illustrates a decision tree for configuring UEs in accordance with embodiments of the present technology.

### DETAILED DESCRIPTION OF THE TECHNOLOGY

### Definitions

As used herein, the term “about” refers to a +/−20% variation from the nominal value. It is to be understood that such a variation is always included in a given value provided herein, whether or not it is specifically referred to.

Unless defined otherwise, all technical and scientific terms used herein have the same meaning as commonly understood by one of ordinary skill in the art to which this technology belongs.

Embodiments of the present technology relate to a mode of operation for transmitting payload data over the LTE system from UEs to the eNodeB (eNB), that is, transmission in the Uplink direction. In some embodiments, the disclosed mode of operation may be used to enable enhanced coverage of up to about 20 dB beyond what is possible using the standard as currently defined. In various embodiments, it is expected to provide between about 1 dB and about 20 dB of coverage enhancement for the M2M UEs to maintain their operability in the edge of current LTE cells.

Embodiments of the present technology relate to enhancements to LTE wireless communication systems. As such, various embodiments operate within the context of LTE communications systems and methods as are known in the art and described in various standard documents. Full operational details of existing LTE systems are not described here, but would be readily understood by a worker skilled in the art. Various acronyms as used herein also derive their meaning from the LTE standard documents. It will be understood that embodiments of the present technology may be applicable to communications systems other than LTE.

In various embodiments, the proposed technology may retain compatibility with the legacy UEs in the LTE system. For example, some resource blocks or portions thereof (e.g. resource elements) may be assigned for use according to legacy operation, while other resource blocks or portions thereof may be assigned for use by UEs operating in accordance with the present technology. Various means for dividing up resources for legacy usage and CDMA mode usage may be employed. In addition, legacy operation may be restored by assigning a CDMA spreading factor of one.

Embodiments of the present technology comprise the use of spreading operations, for example as employed in CDMA (Code Division Multiple Access) systems, within OFDM/OFDMA systems such as LTE. In embodiments, information symbols, for example groups of 12 information symbols, are spread over a number of time slots, for example consecutive or non-consecutive time slots, using the standard time and frequency grid basis of the LTE system, namely a 0.5 ms slot and 15 kHz subcarrier spacing.

The groups of 12 information symbols may correspond to the information symbols carried by the 12 sub-carriers of a LTE resource block. Thus, spreading may be concurrently applied to groups of symbols that, in a legacy LTE implementation, would have been transmitted concurrently on the various adjacent sub-carriers of a resource block. In other embodiments, spreading may be applied to different groups of information symbols, for example all information symbols of a resource block, or potentially to lone information symbols, although this may require other measures to promote spectral efficiency.

Code division multiplexing (CDM) has been specified in the standard for the PUCCH control channel, as mode 3, with a fixed spreading factor of 5, allowing five orthogonal signals to share slots and a range of frequencies. However, the PUCCH control channel is used for control signalling, rather than data. In addition, the fixed spreading factor of 5 places certain limitations on performance of such a CDM scheme. This is described in the 3GPP document TS 36.211 v11.0.0 (2012-09) Section 5.4.2A.

In various embodiments, spreading of a group of infomration symbols to be transmitted by a spreading code of length N_{S} proceeds as follows. N_{S} copies of the group of information symbols are generated, and a spreading code of length N_{S} is also obtained, for example from memory. The first copy of the group of information symbols is then multiplied by the first element of the spreading code; the second copy of the group of information symbols is multiplied by the second element of the spreading code, and so on for all N_{S} copies. The spreading code is selected so that it is substantially orthogonal to other spreading codes in use by other concurrently operating UEs. The output is N_{S} groups of information symbols corresponding to a spread version of the original group of information symbols. These N_{S} groups may be transmitted sequentially in time, for example with each group being transmitted in a different symbol time.

As used herein, a “time slot” may refer to the length of time required to transmit one or more symbols. In some embodiments, six or seven symbols can be transmitted per time slot.

Spreading of information symbols in the above manner allows for concurrent use of LTE resources as follows. Different UEs may spread groups of information symbols using different spreading codes of length N_{S}, and transmit the results in a common set of time slots and a common set of sub-bands. Since the spreading codes are orthogonal, the eNB may then recover the different groups of information symbols transmitted by each UE using CDMA despreading. This may generally comprise multiplying (element-wise) the received signals in the relevant N_{S} time slots by one of the spreading codes to recover the group of symbols of the UE which used that spreading code.

In various embodiments, a group of information symbols may correspond to a group of information symbols which would have been, in terms of legacy LTE operation, transmitted inside a predetermined part of a resource block. For example, the predetermined part of the resource block may be the entire resource block. As another example, the predetermined part of the resource block may be one resource element wide in the time dimension and a plurality of resource elements (e.g. 12) wide in the frequency dimension.

It is noted that, in various embodiments, synchronous or asynchronous CDMA may be employed. Asynchronous CDMA in particular may comprise using appropriate (and possibly not completely orthogonal) pseudorandom codes rather than non-random but orthogonal codes. Synchronous CDMA may utilize pseudorandom or non-random codes.

It has been recognized by the inventors that, in order to achieve an adequate amount of link budget improvement, spreading factors greater than 5 may be required. To facilitate the use of such spreading factors, embodiments of the present technology provide for more sophisticated scheduling and power balancing capabilities than are currently specified for LTE systems.

In various embodiments, a variable spreading factor may be implemented for a UE, the spreading factor selected based on the UE's requirements. For example, a UE on the far limit of coverage may be assigned a large spreading factor, in order to improve communication and provide coverage to the UE. In this case there may be a loss of overall system throughput efficiency if other UEs are not sharing all of the same time and frequency allocations using the other orthogonal spreading codes of the same spreading factor. This may be the case if other such UEs, willing to operate in “CDMA mode” cannot be found by the eNB.

Embodiments of the present technology may facilitate solving this and other problems. For example, in some embodiments, other UEs, whether or not they require spreading for coverage enhancement, may nevertheless be assigned the above-mentioned other orthogonal spreading codes in order to retain adequate system throughput efficiency. These UEs may be described as “code-fillers.” In some cases, these UEs may be transmitter power balanced, with respect to received power at the eNB. Power balancing may be employed, for example, in order to address the known “near-far problem” in CDMA systems. This may comprise reducing transmission power of UEs which have a strong signal as received by the eNB and/or increasing transmission power of UEs which have a relatively weak signal as received by the eNB. A UE may be considered to require coverage enhancement, for example, if a signal quality indicator such as Signal-to-Noise Ratio is less than a predetermined threshold when operating without coverage enhancements.

“Code-filler” UEs may be assigned modulation and coding rates in addition to spreading factors that will require them to transmit longer. In some cases a balance of a higher modulation and/or coding rates together with the spreading may result in substantially little or no difference in the time required for transmission. If the required transmission time is longer than otherwise be realized through legacy LTE modulation and coding methods, the UE may pre-register unwillingness to operate in this mode. This unwillingness may be justified for a number of reasons, which optionally may also be registered. One reason could be that their power supply limitations are sufficiently severe requiring them to be transmitting for the shortest possible time. They may do this because although power amplifier power would be the same, having to transmit for longer will require other circuits to run for longer, negatively impacting battery life for example. Alternatively they may have speed, latency or other requirements that would not be met by participating in “code filling”. In some embodiments, some shorter but also orthogonal codes may be assigned to “code-filler” UEs. However, in many cases there will be a system throughput efficiency trade-off between filling available code space and scheduling them using the legacy standard methods.

In various embodiments, there is provided a method and system which automatically self-configures its use of spreading codes in order to achieve a predetermined balance between spectral efficiency, UE coverage, and energy efficiency. For example, the extent to which spreading codes are used may be configured via interaction between the eNB and the various UEs. Various centralized mechanisms or decentralized mechanisms or both can be used to determine which UEs will utilize spreading codes, to what extent they will be used, and what parameter values, such as spreading factors and scheduling gaps, will govern their usage.

If system loading is light the advantage of coverage extension may be achieved by repetition of the message. This avoids the need to schedule and co-ordinate spreading. This may have the disadvantage that it uses more resources to the exclusion of other UEs and as the number of UEs requiring services increases this may limit system capacity. Using spreading at a factor equivalent to the repetition may use the same amount of resources but with the added advantage that other UEs can share those resources using spreading codes.

This advantage can be exploited if other UEs can be assigned the codes and made to operate using spreading. In various embodiments, neither repetition nor spreading alone is as powerful for coverage extension as Turbo Coding can be when using a coding rate of ⅓ or less. In various embodiments, turbo coding may also be used in embodiments of the present technology, in conjunction with CDMA-type spreading operations as described above. It is recognized that, in various cases, turbo coding alone may provide more coding gain per time/frequency resource used than CDMA spreading gain alone.

Serving M2M devices on the edge of coverage using the techniques of the present technology, or related techniques, may require disproportionate resource allocation due to lower resource efficiency. This may be the basis for premium billing, and various embodiments of the present technology may incorporate premium billing. For example, an eNB may be configured to determine whether a UE may benefit from spread spectrum services and determine an amount of additional resource likely required to provide such services. The service may be offered for a premium fee, which is based on the determined amount of additional resources. That is, user costs may be differentiated based at least in part on coverage enhancement techniques.

In various embodiments, similar or other techniques may be employed in the control channels in order to facilitate various gains as described herein. The amount of coverage improvement made possible by the techniques described herein may require more control than is available via the current control channels of the LTE specification.

In various embodiments, the present technology is configured to utilize specified criteria for assigning operating modes to UEs. Assigning operating modes may include selecting assignments of modulation and coding schemes to various UEs, where the selection may be between legacy formats and those of the present disclosure, for example spread spectrum “CDMA mode” formats. This may be particularly relevant for assigning UEs to operate using spreading of information symbols as described herein when such UEs don't necessarily require coverage enhancement. Specific criteria for assigning operating modes may relate to trade-offs between overall system throughput efficiency and battery life impact on UEs.

In various embodiments, the present technology is configured to account and compensate for the noise effects or interference effects or both of many simultaneous CDMA transmitters and near-far power balancing as seen at the eNB.

Various embodiments of the present technology provide for a low-cost M2M UE coverage enhancement technology for use in LTE systems.

Since the number of the M2M UEs that have data to transmit may change dynamically, a flexible scheduling based on the number of “active” M2Ms UEs that have data to transmit at a given time, may be employed in various embodiments of the present technology. For the same reason, the eNB may be configured to dynamically detect the set of UEs whose performance would be potentially improved if scheduled on the available resources, and may further be configured to intelligently decide when to switch to a “CDMA mode” as described herein.

For various UEs, a TTI bundling with adaptive bundling size may be used by relaxing the delay and medium data rate requirements of TR 36.824. In the context of coverage enhancement, embodiments of the present technology incorporate the use of adaptive TTI bundle size and spreading code lengths, as well as the detailed signaling procedures for flexible assignment of PUSCH to a variable number of UEs by the eNB, for example with higher modulation orders than Quadrature Phase Shift Keying (QPSK).

A non-limiting summary of selected features of the technology as described herein is presented below.

Embodiments of the present technology comprise introducing and using an additional structure which can be dynamically tuned at the eNB to schedule a variable number of M2M and cell-edge UEs in channels such as the PUSCH.

Embodiments of the present technology comprise applying variable-length, orthogonal spreading codes on LTE channels, and particularly shared uplink channels such as the PUSCH. This allows multiple users to transmit at the same RB. This may facilitate achieving system scalability, which is particularly desirable considering the potentially large number of M2M UEs which may require service in a given LTE network.

Embodiments of the present technology comprise dynamically adjusting the TTI bundling size to achieve a desired trade-off between coverage gain and delay, while allowing non-consecutive sub-frame bundling which allows for more time diversity gain and relaxed scheduling constraints at the eNB. Various embodiments comprise coding across a variable number of sub-slots.

Embodiments of the present technology comprise using a variable number of sub-carriers to implement spreading. For example, spread information symbols may be transmitted via an adjustable number of sub-carriers associated with a sequence of resource blocks. The remaining sub-carrier tones may be used to transmit non-spread data, or may be used by another UE.

Embodiments of the present technology comprise introducing dynamic TTI bundling combined with a selective or hybrid ARQ mechanism, in which the eNB requests the UE to only retransmit the redundancy versions with weaker estimated channel qualities.

Embodiments of the present technology comprise providing a signaling procedure which enables the eNB to efficiently coordinate the transmission of a set of UEs via a novel structure as described herein. This may include providing a method for the eNB to determine an optimal or at least sufficiently efficient set of UEs which are to be scheduled using a “CDMA mode” transmission scheme, as well as an optimal or at least sufficiently appropriate time to switch UEs over to this transmission mode.

Embodiments of the present technology comprise, when assigning a UE a large spreading factor for the primary purpose of extending coverage to it, also assigning other UEs to fill the available spreading code space even if they may not need to use this mode for coverage enhancement. This may be done in several ways, as described elsewhere herein.

Embodiments of the present technology comprise allowing UEs to refuse to be assigned this CDMA mode, for example when they do not need it (i.e. they may refuse to operate as “code fillers”. This may be the case, for example, if power supply (battery) limited because although they would be required to transmit at lower power they would be in the powered on state for longer than if able to transmit faster at a higher power, resulting in a higher overall UE power consumption. This corresponds to an example of decentralized resource allocation and/or mode selection, in which the eNB and UEs participate together to determine which UEs will operate in the CDMA mode.

In various embodiments, UEs requiring high data rates and low latency may also exclude themselves from being allocated a CDMA mode that would be detrimental to their communication requirements.

In some embodiments, a UE that is on the edge of coverage may only be able to uplink to the eNodeB using an allocation of large spreading factor CDMA. It may further be assumed that the downlink is capable of reaching the UE and that a control and signalling uplink method is available for the UE to indicate its presence.

Embodiments of the present technology comprise keeping the Transport Block Size (TBS) above a predetermined minimum. For example, keeping to a minimum transport block size of 328 may provide better performance than shorter TBS options with the LTE specified Turbo Coding. Optionally, portions of a data payload may be repeated as necessary to fill out a transmission to at least the minimum TBS.

It will be understood that variable parameters such as spreading code lengths, variable number of sub-slots, variable number of sub-carrier tones, and the like, may be controlled and adjusted using various methods, for example feedback control methods.

The technology will now be described in more detail, with reference to specific examples. It will be understood that these examples are intended to describe embodiments of the technology and are not intended to limit the technology in any way.

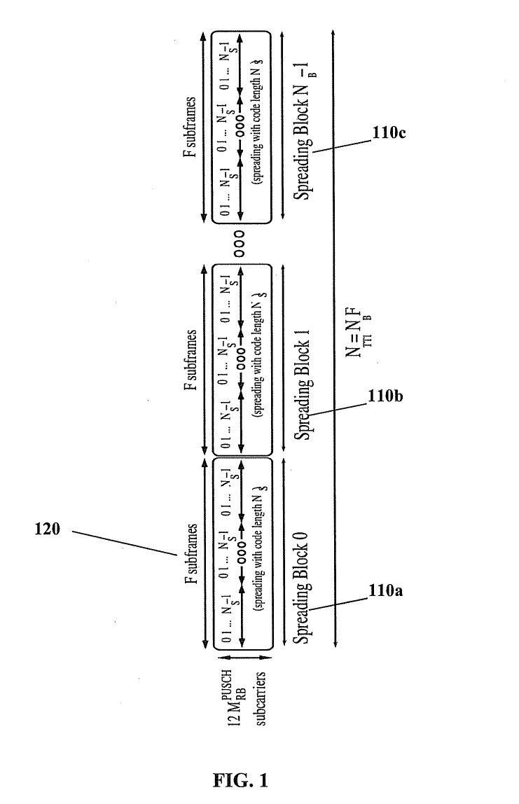

FIG. 1 illustrates a TTI bundle of N_{B} “spreading blocks” 110a, 110b, 110c. In each spreading block, spreading codes of length N_{S} are used for spreading A symbols over one or more (F) sub-frames 120, enabling concurrent transmission by up to N_{S} UEs on the same sub-bands. Different spreading blocks may be scheduled non-consecutively over time and/or frequency.

Benefits of introducing the above features may include the ability to dynamically enhance the coverage based on the system load and channel conditions as well as the scalability to a large number of active M2M UEs.

Embodiments of the present technology comprise a flexible sub-frame structure which adaptively adjusts the spreading code length and the TTI bundle size so that a variable number of UEs can be dynamically scheduled with a dynamically adjustable coverage gain. The TTI bundle sizes and the spreading code lengths in each round of scheduling are determined at the eNB based on the number of UEs which have data to transmit, their required data rate and delay tolerance, and the UL channel estimations during previous transmissions. The coverage enhancement may follow from the spreading gain of the spreading codes and the coding gain of the error correction codes. FIG. 1 shows a unit of the code-spread TTI bundling for this PUSCH sub-frame structure. Details of this embodiment are provided below, and the variables used in designing the structure are listed in Table I.

TABLE I
List of variables

| Variable | Description | Comment |
|---|---|---|
| N_{B} | Number of spreading blocks. | |
| N_{S} | Spreading length. | |
| F | Number of sub-frames in a | F = ( 1/12) lcm(N_{S}, 12) |
| | spreading block. | |
| M_{RB}^{PUSCH} | Number of allocated physical | |
| | resource blocks. | |
| A | Number of data symbols in a | A = 144 M_{RB}^{PUSCH} F/N_{S} |
| | spreading block. | |
| M | Modulation order | M = 2 (default) |
| TBS | Transport Block Size | |
| N_{waiting} | Number of users in the scheduling | |
| | list with the new format | |

In this structure, the coverage gain may be based on one or more of: (i) the coding gain, which is achieved by bundling N_{B} “spreading blocks”. The value of N_{B} can be dynamically chosen for achieving the desired code rate given the transport block size (TBS), as described elsewhere herein; and (ii) the spreading gain, which results from spreading a symbol over N_{S} single-carrier frequency division multiple access (SC-FDMA) symbols.

In various embodiments, spreading blocks allow for enhanced coverage based on the spreading gain. A spreading block corresponds to F (equal to one or more) sub-frame(s) over which a variable number of SC-FDMA data symbols (denoted by A) are spread using spreading codes of length N_{S}. Since 2 symbols per sub-carrier are used as the demodulation reference symbols in a PUSCH sub-frame, there are 12 SC-FDMA data symbols available per sub-carrier and the relation between F, N_{S} and A are given by F=(m/12) N_{S}, with the smallest possible integer m (“1 cm” refers to “least common multiple”) such that F is also an integer, and A=144 M_{RB}^{PUSCH}F/N_{S}, where M_{RB}^{PUSCH} is the number of allocated physical resource blocks (PRBs). Each PRB comprises 12 sub-carriers. The number of SC-FDMA data symbols per sub-carrier in a sub-frame would be further reduced by 1 (i.e. 11) if a sounding reference signal (SRS) is also scheduled as the last symbol of a sub-frame. For this case, the values of F and A can be similarly calculated.

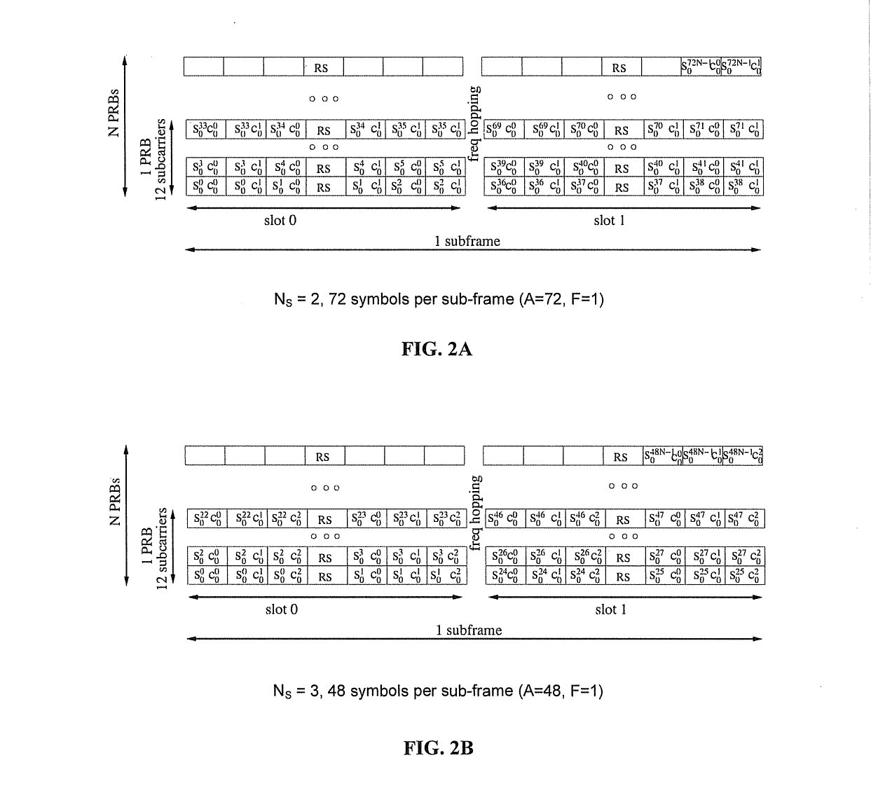

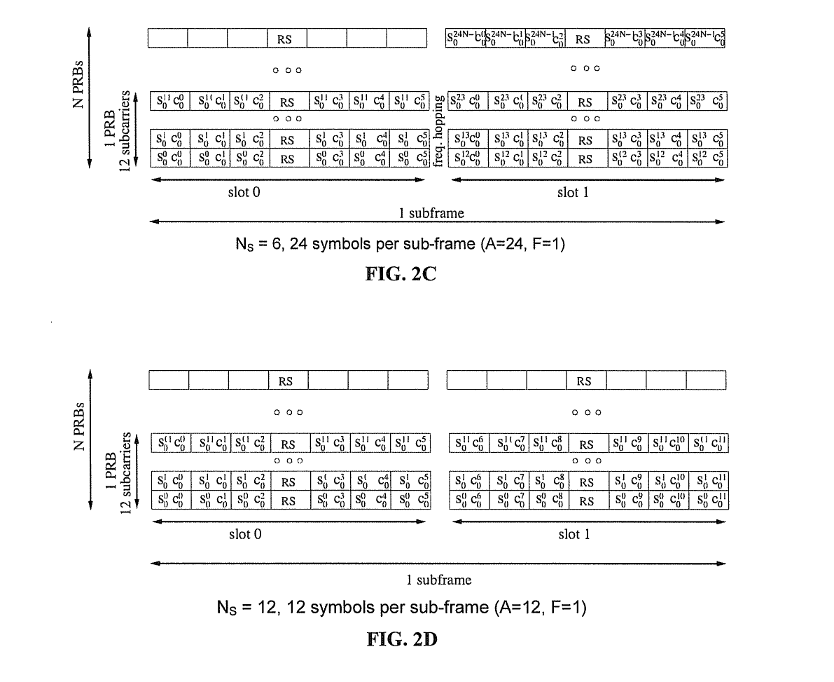

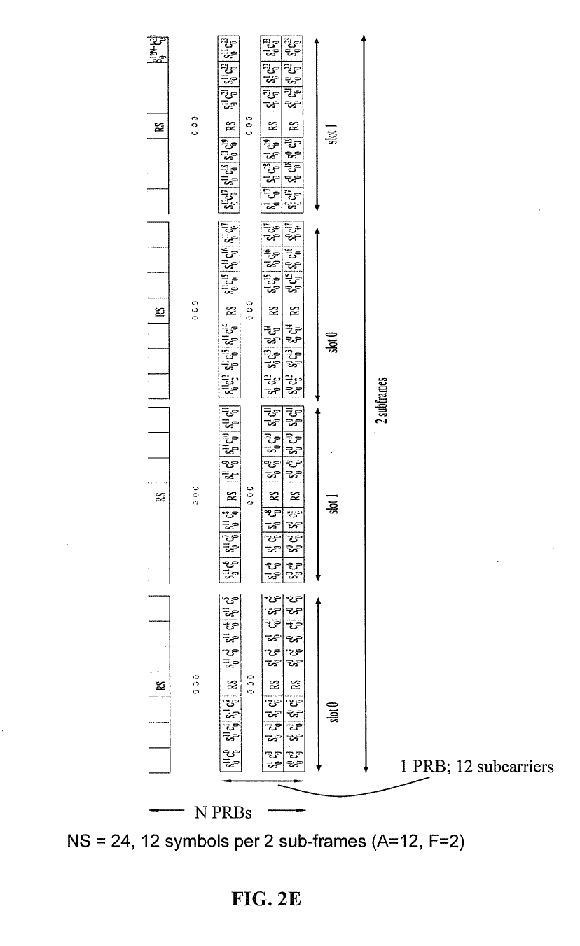

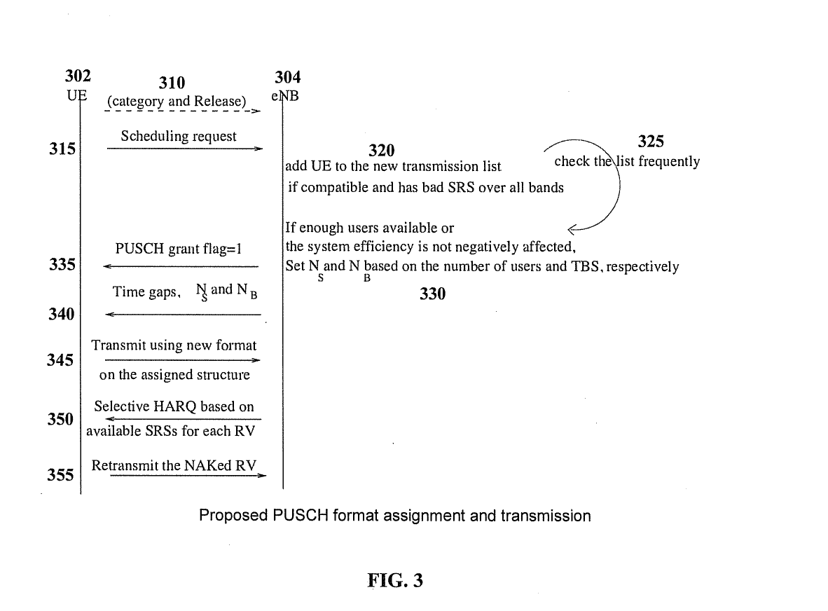

FIGS. 2a to 2e illustrate, in more detail, possible spreading block configurations for the values of N_{S}=2, 3, 6, 12, and 24, respectively. Using N_{S} (possibly orthogonal) spreading codes, up to N_{S} UEs can be scheduled to transmit over the proposed structure. The value of Ns is dynamically adjusted by the eNB based on the required coverage and the number of active users. In various embodiments, a compatible UE is configured to generate different sets of (pseudo-random) spreading codes of length N_{S,1}, N_{S,2}, etc.

An alternative approach is to spread over the frequency domain instead of over the time domain, or to spread over a combination of frequency and time domains. For example, an LTE resource block comprises resource elements arranged across both frequency and time. By applying spreading operations to different patterns or groups of resource elements, spreading over the frequency domain, the time domain, or both, may be achieved.

Based on the selected spreading length and the number of available PRBs, a given TBS can be transmitted by adjusting the value of N_{B} for the desired code rate and redundancy factor. For example, if one PRB is available and a spreading block with the code length N_{S}=12 is used, then the number of coded bits for QPSK modulation (M=2) is M.A=24. Choosing TBS=328, the code rate is r=328/(24 N_{B}), e.g. r=0.34 for N_{B}=40.

Table II shows more possible configurations for selecting N_{B} and their respective TBS, data rate, code rate, and cell spectral efficiency. For a given number of Hybrid Automatic Repeat Request (HARQ) processes, the round trip time (RTT) may also be calculated via Table II. Table TTI bundling is also included as a reference. The coding coverage gain listed in Table II is a lower bound for the coding gain based on repetition codes. The actual coding gain, when for example using Turbo codes, needs to be determined in simulation given a target Block Error Rate (BLER). It is noted that the coding gains listed in Table II are linear, for example as provided on the basis of repeating codes. Different, nonlinear coding gains may be realizedfor other types of codes, such as Turbo codes. For example a rate ⅓ Turbo code may have a coding gain of approximately 9 dB. The actual coding gain should match the coding method used.

TABLE II
Possible combination of N_{B} selection and their performance
(M = 2, BW = 1.4 MHz, M_{RB}^{PUSCH} = 1).

| | | | | | | | Expected | | |
|---|---|---|---|---|---|---|---|---|---|
| | | | | | | | Spreading | | RTT (ms) = |
| | | | | | | | coverage gain | | F N_{H} N_{B} |
| | | | Sym- | | | data rate | (dB) + Coding | Cell | (for N_{H} = 4 |
| | | N_{S} | bols/ | | | (kbps) | coverage gain | spectral | HARQ |
| | | (Max. | sub- | | coding | per user | (dB) = | efficiency | processes, |
| Config- | | No. of | frame | TBS | rate cᵣ = | r = | 10log10(N_{S}) − | (bps/Hz) = | as an |
| uration | N_{B} | Users) | (A/F) | (S) | S/(A.M.N_{B}) | S/(F.N_{B}) | 10log10(c_r) | (N_{S}.r)/1.4e6 | example) |
| C1 | 2 | 2 | 72/1 | 48 | 1/6 | 24 | 3.0 + 7.8 | 0.0343 | 8 |
| C2 | 3 | 3 | 48/1 | 48 | 1/6 | 16 | 4.7 + 7.8 | 0.0343 | 12 |
| C3 | 5 | 6 | 24/1 | 80 | 1/6 | 16 | 7.8 + 7.8 | 0.0686 | 20 |
| C4 | 8 | 12 | 12/1 | 80 | 0.208 | 10 | 10.8 + 6.8 | 0.0857 | 32 |
| C5 | 15 | 24 | 12/2 | 120 | 1/3 | 4 | 13.8 + 4.8 | 0.0686 | 120 |
| C6 | 36 | 2 | 72/1 | 328 | 0.063 | 9.1 | 3.0 + 12.0 | 0.0130 | 144 |
| C7 | 256 | 12 | 12/1 | 328 | 0.053 | 1.28 | 10.8 + 12.8 | 0.0109 | 1024 |
| C8 | 216 | 24 | 12/2 | 328 | 0.063 | 0.76 | 13.8 + 12.0 | 0.0130 | 1728 |
| C9 | 138 | 48 | 12/4 | 328 | 1/10 | 0.59 | 16.8 + 10.0 | 0.0202 | 2208 |
| C10 | 512 | 12 | 12/1 | 800 | 0.065 | 1.56 | 10.8 + 11.8 | 0.0133 | 2048 |
| C11 | 333 | 48 | 12/4 | 800 | 1/10 | 0.60 | 16.8 + 10.0 | 0.0206 | 5328 |
| VoIP | 4 | 1 | 144/1 | 328 | 0.285 | 82 | 0 + ~9 dB | 0.0586 | 16 |

In Table II, for VoIP 12.2 kbps, the packet (244 bits raw) inter-arrival time is actually 20 ms. Here it is assumed that packets arrive every F N_{B}, i.e. every 4 ms.

In various embodiments, the flexibility of the above-mentioned bundle-spread structure allows the eNB to adjust the spreading block size based on the number of UEs which have requested an uplink (UL) assignment, and the number of spreading blocks based on the network load and delay tolerance of the UEs, so that the desired coverage gain can be achieved. The eNB may be configured to intelligently decide when to move to the transmission scheme described herein and which UEs to consider for transmission using the structure as described herein. Moreover, in some embodiments, the non-consecutive scheduling over time and selective HARQ are enabled so that the eNB gains more flexibility on choosing the bundle sizes and assigning them to the UEs. These features will be further explained in the signaling procedure below.

A number of different methods may be used to provide for a desired level of system efficiency. The start of the process may comprise providing the eNodeB with a list of the UEs that wish to communicate together with all of their relevant information. The relevant information may include their link budget requirement, speed, latency and potential restrictions on longer than essential transmission time. The eNode B may be configured to balance the requirements of the UEs with the system loading. For example, the amount of data requested to be transmitted may be balanced against the system capacity in various modes of operation. If system loading is light then UEs may be scheduled using legacy techniques, potentially including UEs requiring coverage enhancement. These UEs may be scheduled to use repetition. If system loading is higher, then spreading may be introduced to the extent it is needed to connect with the UEs that need enhanced coverage and balanced with the system efficiency that can be attained by scheduling other UEs using a combination of spreading and legacy techniques.

In embodiments, one or more of the following parameters may be used to influence when selection of the Spreading Factor (SF): Load on the network (e.g. SF=1 may be used when eNB is not congested); Link budget for UEs (e.g. a higher link budget may tend to trigger use of a higher SF for coverage in many places); and Code utilization (i.e. the % of available orthogonal codes used may influence the spreading factor in use, for example the SF may tend to be lowered in the case of less than 100% code utilization). In some embodiments, all UEs are configured to have ⅓ turbo coding at a minimum, or another predetermined coding rate or coding type or both.

It is recognized that, in various cases, not all UEs make desirable “code fillers”. In various embodiments, determining which UEs to use as “code fillers” may depend on one or more of: Turbo coding rate (e.g. keep at least ⅓ turbo coding); QoS (e.g. pick low through and latency UEs)—(using orthogonal variable spreading factor (OVSF) can help maintain QoS); and Coverage (e.g. pick low coverage UEs to all system maximize spatial re-use). A “code filler” may be defined as a UE which is configured to operate using CDMA spreading codes, as described herein, even though the UE is capable of achieving satisfactory operation or satisfactory coverage or both without using such CDMA spreading codes.

In various embodiments, after the Spreading Factor (SF) gain is determined for a UE, the Coding Gain may be defined as the Required Coverage Gain minus the SF gain. The coding gain may then be used in determining how many TTI's are required in a bundle.

In some embodiments, a method for determining the modes is to select spreading to the extent needed by the UE which needs the most coverage enhancement. Other UEs may then be assigned spreading to the extent they need it or can be assigned as code fillers. This can be done by assigning the UEs lower OVSF spreading factor codes as needed until as many as codes as possible have been filled.

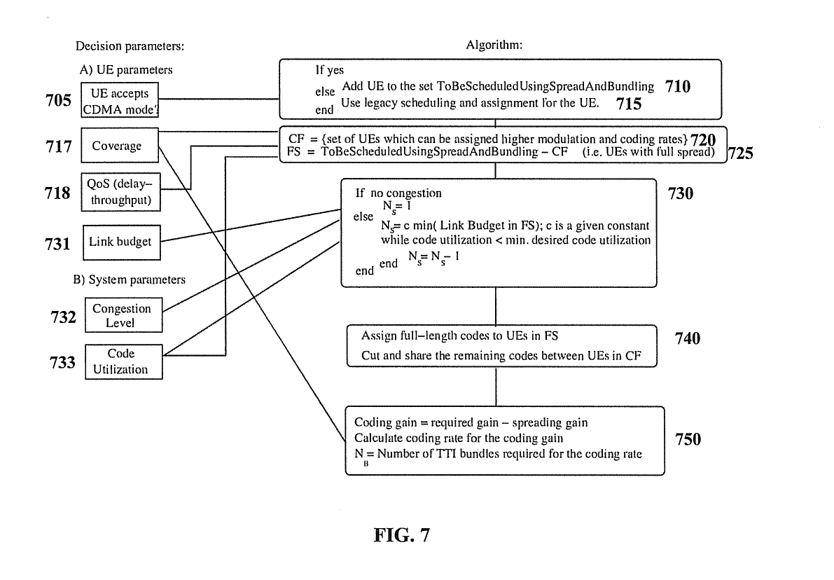

FIG. 7 illustrates a decision tree for performing the above-described selection, in accordance with embodiments of the present technology. A decision 705 is made by the UE whether to accept or decline operation in CDMA mode. If a UE accepts 710 a prompt to operate in CDMA mode, its identity is added to a set “CDMA” of UEs to be scheduled using CDMA spreading and bundling. If a UE rejects 715 a prompt to operate in CDMA mode, legacy scheduling and assignment techniques are applied to that UE. Next, based on factors such as coverage 717, QoS 718, and code utilization, a set “CF” of UEs which can be assigned higher modulation and coding rates is defined 720, and a set “FS” of UEs is defined which includes the UEs in set “CDMA” except for those UEs which are also in set “CF” is defined 725. The set “FS” may be characterized as UEs with “full spread”. Next, based on criteria such as the link budget 731, congestion level 732, and code utilization 733, the spreading code length N_{S} is determined 730. If there is no congestion then N_{S} is set to one. Otherwise, N_{S} is initialized at an amount proportional to the minimum link budget of UEs in the set “FS,” and incrementally decreased until the code utilization reaches or exceeds a minimum desired code utilization. Next, full-length CDMA codes are assigned 740 to UEs in the set “FS.” Next, coding and block size is configured 750 based on the UE coverage. The coding gain is defined as the required total gain minus the achieved spreading gain, the coding rate necessary for the required coding gain is calculated, and the number N_{B} of TTI bundles required for the necessary coding rate is determined.

In various embodiments, “full spread” as used above refers to the amount of spreading required to provide the link budget gain necessary to serve the UEs that most need additional gain in order to achieve reliable communication to the eNB. The most demanding link, i.e. the UE to eNB link, which requires the most additional gain, may define the maximum size of the resource necessary to be used. This sets the size of the space that is to be packed by coordination of the simultaneous transmissions of a number of UEs at that particular block of time. Other UEs may not need as much spreading gain and therefore do not need to be spread as much. These other UEs may be assigned lower spreading factors. The assignment of spreading factors may be performed in order to efficiently use the available orthogonal spreading space in the block. “Full spread” may therefore refer to a variable amount of spreading. If the most demanding UE does not need a large amount of spreading gain then “full spread” spreading may refer to spreading using a relatively short code, in which case fewer code fillers would generally be needed to fill the available code space. UEs that are used for code filling may be able to trade off modulation and coding with spreading to efficiently be used as code fillers. For example, a UE may be assigned a higher order modulation than they would normally be able to tolerate however, their performance can be recovered with coding and spreading.

FIG. 3 illustrates a signaling procedure for deciding on the above-mentioned parameters and assigning the users to TTI-bundled spreading blocks, in accordance with embodiments of the present technology. As can be seen, the following steps are executed by the eNB 304 and UEs 302:

1) When a UE initially joins a cell, it informs 310 the eNB if it supports transmission with dynamic TTI bundling and spreading over blocks of PUSCH. This information can be incorporated into the initial messages where UE informs the eNB about its release and category.

2) When data is available for transmission, the UE sends a scheduling request 315 using PUCCH format 1, 1a, 1b or 3. The same design may also be applied on PUCCH if these channels limit the UL coverage.

3) If the UE supports the new bundling structure and if all the sounding reference signals (SRSs) of the UE indicate relatively poor-quality channels, the eNB adds 320 the UE to a set ToBeScheduledUsingSpreadAndBundling. Otherwise, the eNB would continue with the normal scheduling procedure for that UE.

4) The eNB frequently checks 325 the UEs in the set ToBeScheduledUsingSpreadAndBundling (e.g. every 1 ms or when their new SRSs arrives). If the last received SRS of a UE in this set indicates a relatively good quality channel, then eNB removes that UE from the set and continues to schedule it on its good channel using the normal procedure. Let N_{waiting} denote the number of UEs in the set ToBeScheduledUsingSpreadAndBundling.

5) If one of the following conditions is satisfied,

a) N_{waiting}>⁼N_{ActivationThreshold} for a predefined N_{ActivationThreshold}, or

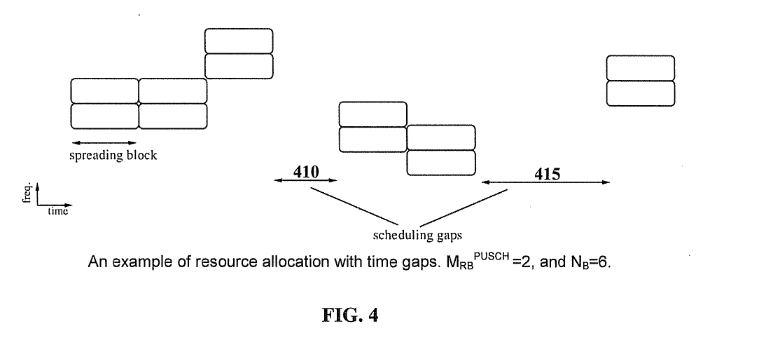

b) The network load allows for scheduling N_{waiting} UEs using the ng the new structure with less than a predetermined amount of negative effect on the cell spectral efficiency; then the eNB sets N_{S} based on the required spreading coverage gain and the number of users and allocates the new structure to all of these UEs 330. The eNB can apply non-consecutive allocation over time to be able to fill the scheduling table more flexibly. FIG. 4 shows an example of this allocation type with 2 scheduling time gaps 410, 415. The UEs are removed from the set after they are successfully scheduled.

6) If either of conditions (a) and (b) in step 5) are satisfied, the eNB responds with a PDCCH DCI format 0 for PUSCH allocation and sets a flag 335 to indicate the transmission must follow the proposed spread-bundle structure rather than an original PUSCH mode. If the non-consecutive scheduling is employed, the time gaps or jumping patterns should be informed to the UE using a new DCI format. For more efficiency, the predefined patterns for frequency hopping at the UE may be reused. See Section 5.3.4 of “Technical Specification Group Radio Access Network; Evolved Universal Terrestrial Radio Access (E-UTRA); Physical Channels and Modulation,” 3GPP TS 36.211 V10.5.0 (2012-06) Technical Specification; Release 10; 3rd Generation Partnership Project, hereinafter referred to as TS 36.211.

7) The value of N_{B} is set to accommodate the given the TBS with the desired code rate, as explained and shown in Table II above.

8) The values of N_{S} and N_{B} along with the scheduling time gaps (if any) are communicated 340 to the corresponding UEs. This may require defining a new DCI.

9) If the flag indicates normal PUSCH transmission, the UE uses legacy UL transmission. Otherwise, the UE first encodes its data with turbo codes of rate ⅓, matches the rates into streams s₀, . . . , s_{NB-1} with HARQ RVs as in the LIE standard (i.e. 0, 2, 3, 1, 0, 2, 3, 1, . . . ), and then spreads sᵢ over the i^{th} spreading block (0<=i<N_{B}). Note that sᵢ contains A symbols, as indicated in Table II. In this manner, the UE transmits 345 in accordance with the present technology.

10) The eNB decodes the transmission of all UEs and acknowledges to each UE if the reception is successful. Otherwise, the eNB performs a selective HARQ method 350 for the next TTI bundling to further improve the performance in terms of block error rate (BLER). More specifically, given the SRSs of the UE for different sub-frames, the eNB can calculate an average channel quality index for each transmitted redundancy version. The RV with the lowest channel quality can then be NAK-ed. Therefore, the next retransmission 355 of a TTI bundle for that UE occurs within a smaller bundle size N_{B} for a better efficiency.

It is noted that the flag in step 6) can be an extension to DCI format 0, or the reuse of a flag that is unlikely to be set for M2M UEs. One candidate is the “distributed PDSCH mapping” mode in DCI format 1A, since, considering the reduced RF bandwidth in M2M UEs, all transmissions would be localized and this flag would be always 0. There should be an implicit or explicit DCI format 1A corresponding to each DCI format 0, e.g., the flag points to the “last” received DCI format 1A by the UE.

Optionally, when the number of UEs is less than N_{S}, the eNB can specify a UE to use more than one available spreading code. For example if 12 users are supported (e.g., in configuration C4 in Table II), but only 10 users are available, then 2 of the users can take advantage of extra codes to increase their data rate.

In accordance with embodiments of the technology, the following hierarchy may be used as a basis for making decisions on how to select UEs for spreading in order to adequately utilize a resource block. This may comprise filling code space in order to achieve adequate system efficiency.

First, if possible, a set of UE's with similar link loss is selected. Such a selection may avoid the near-far power balance issue (need to be within dynamic range of eNB receiver). In various embodiments, the number of selected UEs and the spreading length will match or be numerically close, in order to facilitate efficient use of resources. For long spreading factors and corresponding large numbers of UEs, scheduling and power balancing may become more computationally intensive. For example, there may never be a time when all codes are used and this will result in system efficiency degradation. This degradation may be made the basis for a selective billing policy.

Second, if not enough UEs can be grouped using the above approach, a heterogeneous group may be selected. While three alternative options for selecting heterogeneous groups are described below, other options may be possible and are considered to be within the scope of the instant invention.

In the first option, some “code filler” UEs that do not need spreading may be spread regardless, in order to fill the codes. Furthermore, it is considered that, rather than uniformly applying a spreading factor to all the UEs that would be required to achieve coverage for the most extreme UEs in the group, a lesser spreading factor may be used. Repetition may then be used in conjunction with spreading for the more extreme UEs to achieve coverage. For example, data may be repeated and then spread, or spread and then repeated. Data may be repeated more times for UEs requiring higher gain and fewer times or not at all for UEs not requiring maximum gain. When data is repeated fewer times, the extra capacity may be used to transmit other pending data from the UE. A consideration is that high speed “code filler” UEs may undesirably limit overall throughput speed. Another consideration is that repetition may use more resources than spreading, although it may be applied more selectively to individual terminals. For example, pure repetition approaches would not require “code filler” UEs.

A second option proceeds as above, but high speed UEs in better coverage are assigned a plurality of the relatively longer codes so that they can maintain their speed since they may not require the spreading in order to obtain an adequate performance level. UEs requiring coverage enhancement can use the long spreading codes without repetition. This may lead to improved performance in some cases. As an example, UE#1 and UE#2 may be assigned one code with SF=4 each. UE#3 may be assigned two codes with SF=4 (6 dB gain) with half the power (3 dB loss). To maintain speed UE#3 may also use a higher order modulation, e.g. 64 QAM.

A third option is to use spreading codes of different lengths for different UEs. An example of such spreading codes is OVSF (Hadamard Codes). This may reduce a potential repetition vs. turbo coding degradation. The eNB may be configured to select UEs with similar path loss to be able to balance transmitter powers to address the near-far problem. As an example, UE#1 and UE#2 are assigned one code of SF=4 each, and UE#3 is assigned one code of SF=2 (3 dB gain). To maintain speed, UE#3 may use less coding, e.g. 64 QAM with rate ½ turbo coding so that it keeps the same net gain it would have had with 64QAM and rate ¼ turbo coding and no spreading.

It is noted that Turbo coding has more error correction gain than CDMA spreading at higher coding rates but the difference is less significant for low rate codes (< 1/15 for example). Therefore, using Turbo coding instead of spreading may be desirable and may be achieved by using larger constellation sizes, since the power efficiency loss due to larger constellation sizes is compensated by the spreading gain for constant rate.

In various embodiments, following or concurrently with grouping of UEs as described above, the present technology may be configured to avoid assigning any UE's to CDMA spreading that are in good coverage where their MCS cannot be in increased (e.g. 64QAM with 1/1 coding). Such UEs may be required to operate for longer if made to spread and signal quality improvement will generally be unnecessary for them. The present technology may be configured to at least partially avoid causing UEs to utilize CDMA spreading if it will not increase a utility, which is a function of the UE's throughput performance, “on time” or battery performance and the overall system performance.

It is noted that, although spreading in time has been described in detail herein, spreading in frequency, or spreading in both time and frequency, have been contemplated as valid alternatives. Some cases of time domain spreading may suffer loss of orthogonality due to time varying channel characteristics over the duration of the spread. This is more likely to happen for long spreading factors. It is noted that similar loss of orthogonality can happen to frequency domain spreading due to frequency selective channel gains.

Selected differences between embodiments of the present technology and the legacy PUSCH foiuiat as identified in the 3GPP document: TS 36.211 “Evolved Universal Terrestrial Radio Access (E-UTRA); Physical channels and modulation” Release 11, (Section 5.3) are identified below:

scrambling: may remain unchanged.

modulation of scrambled bits to generate complex-valued symbols: All modulation levels in Table 5.3.2-1 (QPSK, 16QAM, and 64QAM) are supported and can be adaptively adjusted by changing I_MCS. For a method according to the instant technology, M_{Symb} is substantially at a maximum when equal to A M_{RB}^{PUSCH}v, wherein v is the number of antenna layers and M_{RB}^{PUSCH} is the number of assigned PRBs. The transmission of more symbols can be postponed to the next HARQ process.

mapping of the complex-valued modulation symbols onto one or several transmission layers: may remain unchanged.

transform precoding to generate complex-valued symbols: prior to this step, UEs may be configured to spread the symbols with its code according to FIG. 2.

precoding of the complex-valued symbols (DFT operation): A DFT of size 12.M_{RB}^{PUSCH} is applied.

mapping of precoded complex-valued symbols to resource elements: The N_{S} spread elements of each symbol may be mapped according to the selected spreading pattern.

generation of complex-valued time-domain SC-FDMA signal for each antenna port: may remain unchanged. Note that the frequency hopping in Section 5.3.4 of TS 36.211 may be applied.

It is noted that embodiments of the present technology may be applied to various UE categories, for example for the purpose of coverage enhancement at the cell edge, and such embodiments are not necessarily limited to the application, e.g. low or medium data rate or VoIP.

In various embodiments, it is required that the release of the UE and its category, which is known to the eNB at the time of initial cell search, supports this type of UL transmission.

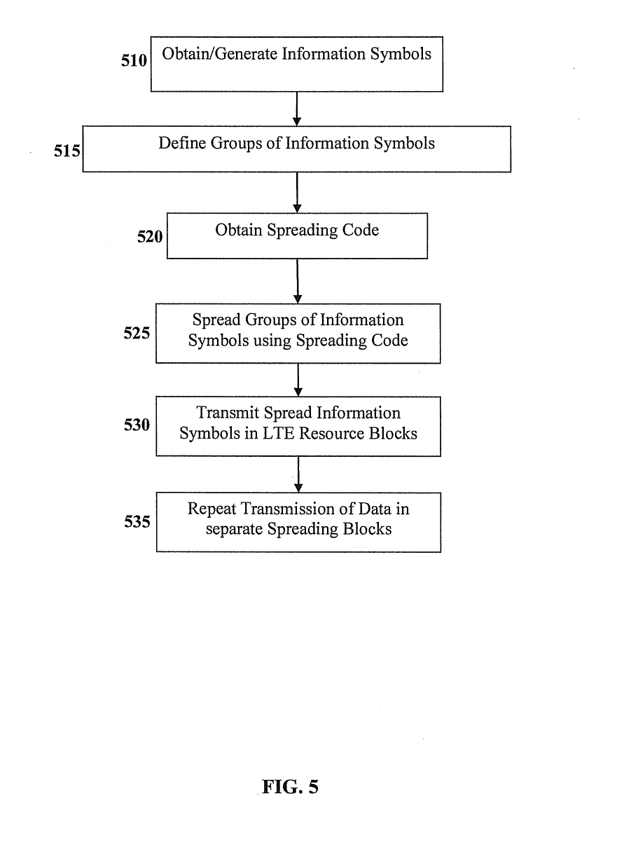

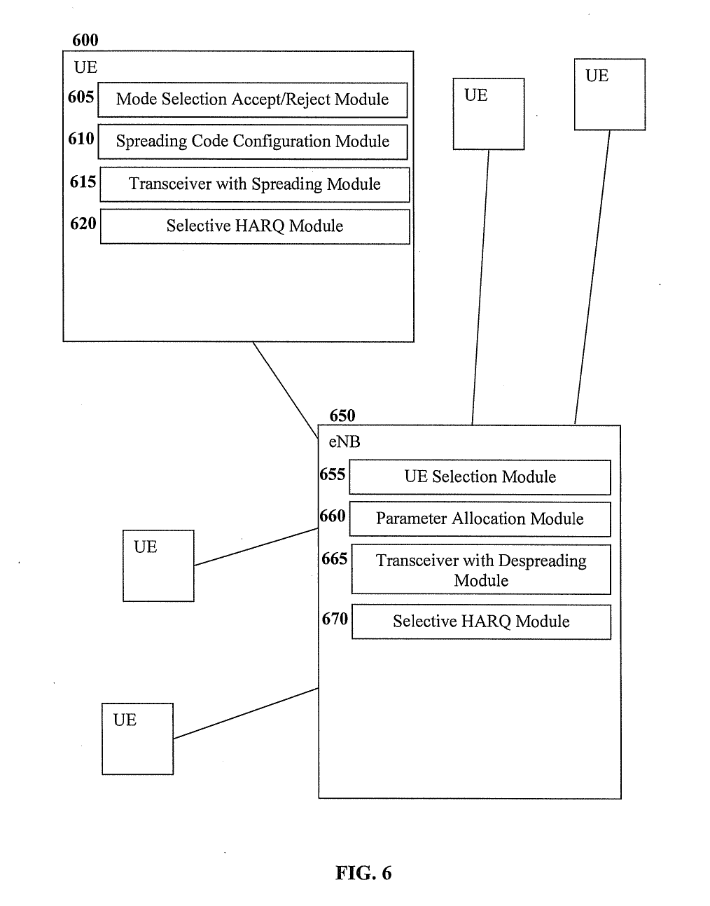

FIG. 5 illustrates a method for transmitting data from a UE in accordance with embodiments of the present technology. The method comprises obtaining or generating 510 information symbols to be transmitted. The method further comprises defining groups 515 of one or more information symbols in a predetermined manner. The method further comprises obtaining 520 a spreading code of a specified length. For example, the spreading code length may be dynamically specified by the eNB. The method further comprises spreading 525 each group of information symbols using the obtained spreading code. The method further comprises transmitting 530 the spread information symbols in one or more LTE resource blocks. The method further comprises repeating 535 transmission of the data in separate spreading blocks, optionally using different encodings.

It will be readily understood that aspects of the technology as described herein may be provided in the form of an appropriate computer or computing system, such as a mobile terminal, M2M terminal, eNB, or the like, or by a system of components in communication with each other via an LTE wireless communication network. Existing LTE terminals and eNBs may be modified in accordance with the present technology, for example by providing additional or replacement functional modules. Such functional modules may comprise appropriate hardware, software, firmware, or a combination thereof. For example, terminals, servers, network controllers, eNBs, and the like, may operate as described herein partially by causing a microprocessor or set of microprocessors to execute instructions stored in memory. The microprocessor in turn may cause other electronic components to operate as instructed, for example to process signals, transmit and receive radio signals, and the like. In some embodiments, hardware or firmware-enabled hardware, such as microcontrollers, digital signal processors, or the like, may be used in a similar manner. In general, general-purpose or dedicated electronic components, as will be readily understood by a worker skilled in the art, will be used to implement the various functionalities as described herein. Various functionalities as described herein may be achieved via reconfiguration of existing hardware, software and/or firmware.

In various embodiments, there is provided a UE device, such as a mobile terminal or M2M terminal, which comprises a communication module configured to perform spreading operations as described herein, as well as related control operations, coordination with an eNB, channel coding, TTI bundling, and the like, as described elsewhere herein. The communication module may be configured to perform the appropriate modulation, spreading and scheduling operations, as well as physical communication.

In various embodiments, there is provided a base station, such as an eNB, which comprises a control module configured to generate and transmit control signals to various UE terminals. The control signals may be generated in order to direct UE operations based on considerations such as spectral efficiency, communication delay, throughput, coverage, power budgets, and the like. The control signals may specify which UEs are to operate using spreading operations and which UEs are to operate using legacy techniques. The control signals may further specify time, frequency or code schedules or both for use by the UEs. The control signals may be generated using one or more performance optimization algorithms, for example. The control signals may be transmitted to the UEs via a downlink control channel, for example.

In some embodiments, if only a few UEs require spreading, then the eNB may be configured to assign legacy formats with significant repetition in order to avoid the need to group and schedule others to use up code space to retain system throughput efficiency.

In some embodiments, if an eNB has a full set of spreading UEs transmitting to it, the noise floor in that band is expected to be higher and that may give problems for adjacent cells. In further embodiments, adjacent cells may be configured so as not to perform maximum spreading in the same band at the same time because it may be probable that the UEs will mutually block each other with high noise. (due to low SNR at the respective eNBs).

FIG. 6 illustrates a system, and in particular a UE 600 and eNB 650, configured in accordance with embodiments of the present technology. The eNB 650 comprises a UE selection module 655, which is configured to select UEs communicatively coupled to the eNB for operation in a spreading mode as described herein, via selection messages. UE selection may be based on various criteria, such as UE's acceptable MCS/SF configuration, UE's QoS requirements, coverage, spectral efficiency and energy considerations. The eNB further comprises a parameter allocation module 660, which is configured to determine parameters such as spreading lengths, number of spreading blocks, time gap allocations, and the like, to be used by selected UEs during operation. Parameters may again be allocated based on various criteria, such as QoS requirements, coverage, spectral efficiency and energy considerations. The eNB further comprises a transceiver 665, (which may be a receiver only) having a despreading module capable of receiving and despreading transmissions from UEs. The eNB further comprises a selective HARQ module 670.

The UE 600 comprises a mode selection accept/reject module 605, which is configured to accept or reject selection messages transmitted by the UE selection module 655. For example, if the UE 600 does not require spreading operations to achieve coverage, and operating in such a mode would represent an unacceptable energy burden, then the UE may reject the selection message. The UE further comprises a spreading code configuration module 610, which is configured to obtain a desired spreading code length and corresponding spreading code for use in spreading information symbols. Spreading code parameters such as length may be obtained from the eNB via a configuration message. The UE further comprises a transceiver 615 (which may be a transmitter only) having a spreading module, the transceiver configured to transmit information symbols with spreading as described elsewhere herein. The transceiver may further comprise a variable coding module, coding block repetition module, and the like. The UE further comprises a selective HARQ module 620. Alternatively, the mode selection accept/reject functionality may be provided in the eNB.

It will be appreciated that, although specific embodiments of the technology have been described herein for purposes of illustration, various modifications may be made without departing from the spirit and scope of the technology. In particular, it is within the scope of the technology to provide a computer program product or program element, or a program storage or memory device such as a solid or fluid transmission medium, magnetic or optical wire, tape or disc, or the like, for storing signals readable by a machine, for controlling the operation of a computer and/or firmware according to the method of the technology and/or to structure its components in accordance with the system of the technology.

In addition, while portions of the above discuss the technology as it can be implemented using a generic OS and/or generic hardware, it is within the scope of the present technology that the method, apparatus and computer program product of the technology can equally be implemented to operate using a non-generic OS and/or can use non-generic hardware.

Further, each step of the method may be executed on one or more appropriate computing devices, such as M2M devices, personal computers, servers, base stations, or the like, or system of computing devices, and pursuant to one or more, or a part of one or more, program elements, modules or objects generated from any programming language, such as C++, C#, Java, PL/1, or the like. In addition, each step, or a file or object or the like implementing each said step, may be executed by special purpose hardware or a circuit module designed for that purpose.

It is obvious that the foregoing embodiments of the technology are examples and can be varied in many ways. Such present or future variations are not to be regarded as a departure from the spirit and scope of the technology, and all such modifications as would be obvious to one skilled in the art are intended to be included within the scope of the following claims.

What is claimed is:

1. A method for transmitting data from a transmitter configured for wireless communication in an OFDM system, the method comprising:
a.) obtaining information symbols indicative of said data;
b.) spreading each of the information symbols using a spreading code assigned to the transmitter, the spreading code being different from spreading codes of other transmitters in the OFDM system; and
c.) transmitting the spread information symbols in one or more time and frequency resource blocks defined for the OFDM system.

2. The method according to claim 1, wherein the resource blocks belong to a data channel shared by a plurality of separate transmitters including the transmitter.

3. The method according to claim 2, wherein the plurality of separate transmitters transmit concurrently using a common set of subcarriers of the resource blocks, said concurrent transmissions differentiated by use of different spreading codes.

4. The method according to claim 1, wherein the spreading code has a spreading factor which is selected based on one or more system performance criteria.

5. The method according to claim 1, wherein the spreading code is orthogonal to spreading codes of said other transmitters in the OFDM system.

6. The method according to claim 1, wherein the transmitter is associated with a UE.

7. The method according to claim 1, wherein each of the information symbols is transmitted over a plurality of time slots.

8. The method according to claim 1, wherein spreading the information symbols comprises generating N_{S} copies of a group of information symbols, multiplying each of the copies by a corresponding element of a spreading code of length N_{S}, and transmitting the results during a plurality of different time intervals.

9. The method according to claim 1, wherein the spreading code is assigned by an eNB.

10. The method according to claim 9, wherein spreading code assignment is based on one or more considerations selected from the group comprising: network load, UE coverage requirements, UE link budgets, and a proportion of codes used.

11. The method according to claim 1, further comprising coding of data into information symbols extending over a plurality of spreading blocks.

12. The method according to claim 1, further comprising use of one or both of: coding of the information symbols and repetition of the information symbols, in conjunction with spreading of the information symbols.

13. The method according to claim 1, further comprising configuring a variable number of sub-carriers for use in transmitting the spread information symbols.

14. The method according to claim 1, wherein spreading of the information symbols comprises spreading across frequency and time.

15. The method according to claim 1, wherein two or more spreading codes are assigned for concurrent use by the transmitter.

16. A method for controlling data transmission from a set of transmitters in an OFDM system, the method comprising:
a.) selecting one or more transmitters from the set of transmitters;
b.) transmitting a message to the selected one or more transmitters, the message comprising instructions to transmit data in accordance with the method of claim 1; and
c.) at each of the selected one or more transmitters, accepting or rejecting said instructions.

17. The method according to claim 16, wherein selection of the one or more transmitters is based on one or more considerations associated with one or more UEs, each UE associated with one of the one or more transmitters, the considerations selected from the group comprising: UE maximum MCS; UE capabilities; UE accepted configurations; the UE's QoS; coverage; and spectral efficiency.

18. The method according to claim 16, wherein the message is indicative of one or more different spreading factors to be used by respective ones of the selected one or more transmitters.

19. The method according to claim 16, wherein the set of transmitters includes a legacy set of one or more transmitters which are configured to transmit data in accordance with a legacy mode, and wherein a first set of resource blocks is assigned for use by the legacy set of one or more transmitters and a different set of resource blocks is assigned for use by transmitters transmitting data in accordance with the method of claim 1.

20. The method according to claim 16, wherein said selection of one or more transmitters is performed in order to cause a predetermined number of transmitters to transmit data in accordance with the method of claim 1, wherein said predetermined number is selected to achieve at least a predetermined spectral efficiency.

21. The method according to claim 20, wherein said selection of one or more transmitters includes selection of at least one transmitter which would have achieved adequate coverage if transmitting data in accordance with a legacy mode.

22. The method according to claim 16, wherein said selection of one or more transmitters comprises dynamic selection based at least in part on a potential for coverage improvement for each of said one or more transmitters.

23. The method according to claim 16, further comprising configuring a TTI bundle size and a spreading code length, thereby facilitating scheduling a variable number of transmitters with adjustable coverage.

24. The method according to claim 16, wherein at least one of the one or more transmitters is configured to use less than a highest required spreading code in conjunction with repetition of data to be transmitted in order to achieve a desired coverage.

25. A user equipment (UE) configured for implementing enhanced communication in an LTE system, the UE comprising:
a.) a source of data;
b.) a transceiver module configured to: obtain information symbols indicative of said data; spread the information symbols using a spreading code assigned to the UE, the spreading code being substantially orthogonal to spreading codes of other UEs in the LTE system, the spreading code having a spreading factor which is selected based on one or more system performance criteria; and transmit the spread information symbols in one or more LTE resource blocks.

26. A system configured for implementing enhanced communication in an LTE system, the system comprising:
a.) a base station (eNB); and
b.) the user equipment according to claim 25.

27. The system according to claim 26, wherein the base station further comprises:
a.) a UE selection module configured to select one or more UEs in the LIE system for operation;
b.) a parameter allocation module configured to define spreading parameters for the selected one or more UEs; and
c.) a transceiver configured to perform de-spreading operations on signals received from the selected UEs.

28. A computer program product comprising a computer readable memory storing computer executable instructions thereon that when executed by a computer perform the method of claim 1.
